(19) United States
(12) Patent Application Publication
(10) Pub. No.: US 2010/0082370 A1
(43) Pub. Date: Apr. 1, 2010

(54) CLINICAL EVENT TRACKING AND ALERTING SYSTEM

(76) Inventors: Perry Frederick, Palo Alto, CA (US); Vijaykalyan Yeluri, Sunnyvale, CA (US); Prakash Mahesh, Hoffman Estates, IL (US); Robert John Herfkens, Stanford, CA (US); Denny Lau, Emeryville, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/242,090

(22) Filed: Sep. 30, 2008

(51) Int. Cl. G06Q 50/00

(52) U.S. Cl. 705/3

(57) ABSTRACT

Clinical information tracking and alerting systems are disclosed herein. An example method of providing feedback to healthcare practitioners includes receiving a subscription to clinical information associated with a patient from a healthcare practitioner; searching a database of shared clinical information to identify recently entered clinical information, wherein searching the database is automated to be performed according to a schedule; determining whether the recently entered clinical information includes medical data associated with the patient; and publishing the medical data associated with the patient to the healthcare practitioner.

### FIELD OF THE DISCLOSURE

The present disclosure relates generally to healthcare information systems and, more particularly, to a clinical event tracking and alerting system.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during an ongoing medical procedure.

Medical practitioners, such as doctors, surgeons, and other medical professionals, rely on the clinical information stored in such systems to assess the condition of a patient, to provide immediate treatment to a patient in an emergency situation, to diagnose a patient, and/or to provide any other medical treatment or attention. Moreover, some information systems enable practitioners and/or healthcare facilities to share clinical information, especially given the increase in use of electronic records.

### SUMMARY

An example method of providing feedback to a healthcare practitioner includes receiving a subscription to clinical information associated with a patient from a healthcare practitioner. Further, the example method includes searching a database of shared clinical information to identify recently entered clinical information, wherein searching the database is automated to be performed according to a schedule. Further, the example method includes determining whether the recently entered clinical information includes medical data associated with the patient. Further, the example method includes publishing the medical data associated with the patient to the healthcare practitioner.

An example apparatus to provide feedback to a healthcare practitioner includes a subscription log to store a subscription to clinical information associated with a patient, wherein the subscription is received from a healthcare practitioner. Further, the example apparatus includes a polling unit to search a database of shared clinical information to identify recently entered clinical information and to determine whether the recently entered clinical information includes medical data associated with the patient, wherein the polling unit is to search the database automatically according to a schedule. Further, the example apparatus includes a communication interface to publish the medical data associated with the patient to the healthcare practitioner.

An example medical data sharing system configured to provide feedback to a healthcare practitioner includes a plurality of medical information systems to receive clinical information implemented at a plurality of healthcare enterprises, wherein the enterprises are members of an agreement to share the clinical information. Further, the example medical data sharing system includes a plurality of repositories implemented to store the clinical information. Further, the example medical data sharing system includes a registry, in communication with the repositories, to store identifying data associated with the clinical information. Further, the example medical data sharing system includes a tracking and alerting system to automatically provide feedback to a plurality of healthcare practitioners by storing a plurality of subscriptions to clinical information associated with a plurality of patients, searching the registry to identify recently entered clinical information, wherein searching the registry is automated to be performed according to a schedule, and publishing the recently entered clinical information to a group of the healthcare practitioners according to the subscriptions.

### BRIEF DESCRIPTION OF THE DRAWINGS

FIG. 1 is a block diagram of an example medical information system.

FIG. 2 is a block diagram of an example apparatus that may be used to implement the example event tracking and alerting system of FIG. 1.

FIG. 3 is a flow diagram representative of example machine readable instructions that may be executed to implement the example event tracking and alerting system of FIGS. 1 and/or 2.

FIG. 4 is a block diagram of an example processor system that may be used to execute the machine readable instructions of FIG. 3 to implement the example record organizer of FIG. 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods and apparatus described herein can be used to provide a clinical event tracking and alerting system. In particular, the example methods and apparatus described herein provide a feedback loop for one or more healthcare professionals to automatically inform the healthcare professionals of recent clinical events involving formerly treated patients and/or current patients (e.g., a patient under the care of a multi-physician team). The feedback loop notifies the healthcare professionals of new developments associated with the type of previously provided treatment. For example, if a patient undergoes a medical procedure for stomach cancer (e.g., with an oncologist), a gastroenterologist that the patient visited the previous year automatically receives a notification, along with the corresponding medical information (e.g., modality, severity, prescriptions, test results, and/or any medical report), from the example tracking and alerting system described herein. Thus, unlike typical clinical information systems, the example tracking and alerting system described herein enables a physician to, for example, confirm a diagnosis, be informed of a misdiagnosis, reevaluate a treatment approach for the previous patient, current patients, and/or future patients, and/or otherwise learn from the new information associated with the new clinical events.

Further, the example methods and apparatus described herein provide updates to members of a treatment team (e.g., a group of physicians from various areas of medicine treating a patient). Treatments involving a plurality of physicians across medical specialties are more becoming more common, especially given the increase in sub-specialties and the prevalence thereof In such instances, the example tracking and alerting system described herein enables the different physicians to better collaborate on the care of the patient and to follow the medical events occurring throughout the treatment process (e.g., by being automatically updated when the patient experiences or undergoes a relevant medical event).

As described in greater detail below, the feedback loop of the example tracking and alerting system described herein is implemented by a subscribe-publish model. Generally, the subscribe-publish model enables a plurality of healthcare practitioners to subscribe to any future clinical events associated with one or more patients. The example tracking and alerting system tracks clinical events (e.g., test results, procedures, complications, etc.) that are entered into a medical information system, preferably as the events occur (e.g., immediately after or during an examination) or at least shortly thereafter. To publish relevant clinical events to one or more subscribing practitioners, the medical information system is periodically (or in response to a query) polled to obtain data associated with newly entered clinical events. Medical data obtained from the polling process is then communicated to the corresponding subscribing practitioners. In some examples, the obtained medical data is also screened and/or or filtered to restrict any communicated information to the medical data that is pertinent to the previous treatment provided by the subscribing practitioner. For example, a cardiologist who has subscribed to a patient that the cardiologist treated the previous year for an arrhythmia may not receive a medical event (e.g., the example tracking and alerting system may not publish the report associated with the medical event to the cardiologist) in which the patient fractured a wrist. On the other hand, the cardiologist may receive a notification if the patient experiences stroke-related symptoms or actually suffers a stroke.

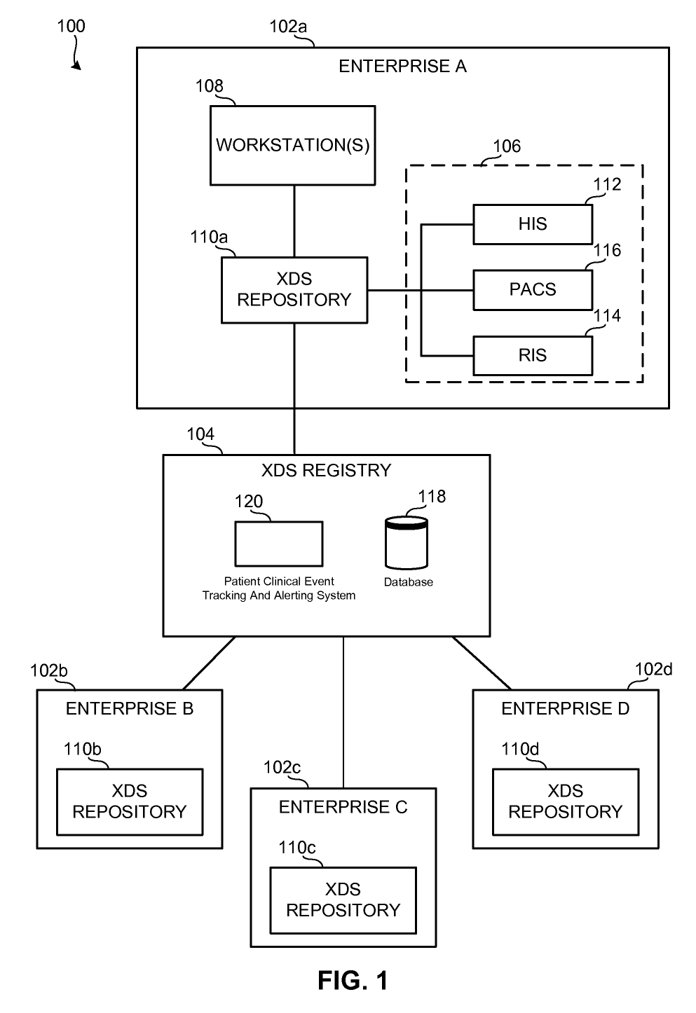

The example methods and apparatus described herein to provide a clinical event tracking and alerting system can be implemented on any suitable medical data sharing system. For example, the example tracking and alerting system described herein can be implemented in a Cross-Enterprise Document Sharing (XDS) system, which is being developed by the Integrating Healthcare Enterprise (IHE). With the increase in use of electronic medical records, there is an increased recognition of the advantages of sharing medical data among healthcare facilities (e.g., a physician's office, a hospital, a clinic, etc.). This has led to the development of medical data sharing systems such as the XDS system. In particular, the XDS system is an integration profile that facilitates registration, distribution, and access to medical data among a plurality of healthcare facilities or enterprises. The XDS profile establishes a common set of policies for a group (referred to as an Affinity Domain in IHE XDS terminology) of healthcare facilities or enterprises that have agreed to share medical data using a common infrastructure. As shown in greater detail below in connection with FIG. 1, an XDS system generally includes four main components: (1) a document registry to index medical reports using metadata or other identifying data; (2) document sources that provide data related to medical events (e.g., test results, medical reports, and/or metadata associated with the medical reports); (3) one or more document repositories that store medical reports and communicate with the document registry to retrieve documents to be shared; and (4) one or more document consumers that receive information associated with medical events.

The example tracking and alerting system described herein can also be configured to be interoperable with other information systems, such as physician portal type applications. In such instances, the example tracking and alerting system provides a subscription application programming interface (API) to enable third party applications on behalf of the physician to subscribe to clinical information associated with patients.

FIG. 1 is a block diagram of an example medical data sharing system 100 capable of implementing the example methods and apparatus described herein to provide a clinical event tracking and alerting system. The example medical data sharing system 100 of FIG. 1 implements an XDS integration profile to facilitate the sharing of medical data among a plurality of healthcare enterprises 102a-d via a common registry 104. While the example medical data sharing system 100 of FIG. 1 is shown as implemented by an XDS integration profile, any other or additional suitable medical data sharing system can be used to implement the example methods and apparatus described herein.

In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown for purposes of brevity and not limitation.

The example hospital 102a includes a medical information system 106, one or more workstations 108, and a repository 110a. The medical information system 106 includes a hospital information system (HIS) 112, a radiology information system (RIS) 114, and a picture archiving and communication system (PACS) 116. In the illustrated example, the hospital information system 112, the radiology information system 114, and the PACS 116 are housed in the hospital and locally archived. However, in other implementations, the hospital information system 112, the radiology information system 114, and/or the PACS 116 may be housed one or more other suitable locations. Furthermore, one or more components of the medical information system 106 may be combined and/or implemented together. For example, the radiology information system 114 and/or the PACS 116 may be integrated with the hospital information system 112; the PACS 116 may be integrated with the radiology information system; and/or the three example information systems 112, 114, and/or 116 may be integrated together. Preferably, information (e.g., test results, observations, diagnosis, etc.) is entered into the hospital information system 112, the radiology information system 114, and/or the PACS 116 by healthcare practitioners (e.g., radiologists, physicians, and/or technicians) before, after, and/or during a patient examination and/or testing session.

The hospital information system 112 stores medical information such as clinical reports, patient information, and/or administrative information received from, for example, personnel at a hospital, clinic, and/or a physician's office. The radiology information system 114 stores information such as, for example, radiology reports, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film). In some examples, information in the radiology information system is formatted according to the HL-7 (Health Level Seven) clinical communication protocol.

The PACS 116 stores medical images (e.g., x-rays, scans, three-dimensional renderings, etc.) as, for example, digital images in a database or registry. In some examples, the medical images are stored in the PACS 116 using the Digital Imaging and Communications in Medicine (DICOM) format. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116.

The hospital information system 112, the radiology information system 114, and/or the PACS 116 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a private network, a wired or wireless Local Area Network, and/or a wired or wireless Wide Area Network. In some examples, the medical information system 106 also includes a broker (e.g., a Mitra Imaging's PACS Broker) to allow medical information and medical images to be transmitted together and stored together.

The workstation(s) 108 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc. The workstation(s) 108 can communicate with each other, the medical information system 106, and/or, as described in greater detail herein, with the XDS repository 110a and registry 104 to obtain shared medical information and convey the same to the user of the workstation(s) 108. Further, the workstation(s) 108 are capable of implementing a user interface to enable a healthcare practitioner to interact with the medical data sharing system 100 and/or the registry 104 and the components thereof. Additionally, the user interface includes one or more options related to the example methods and apparatus described herein to provide a feedback loop regarding clinical events.

The repository 110a, which is shown as an XDS repository in the example of FIG. 1, facilitates the sharing of the documents generated by the medical information system 106 with other enterprises (e.g., enterprises 102b-d). In particular, the repository 110a receives images, medical reports, administrative information, and/or other clinical information from the medical information system 106 and stores such information in, for example, a database or any suitable data structure. Thus, to use XDS terminology, the medical information 106 is a document source that provides the repository 110a clinical data to be shared among the enterprises 102a-d. If necessary (e.g., when different formats of the received information are incompatible), the repository 110a translates or reformats (e.g., into Structured Query Language (SQL or standard text) the medical information, such as medical reports, to be properly shared among the enterprises 102a-d (e.g., to conform with the XDS integration profile). In some examples, the medical information is stored in, for example, the DICOM format, which enables medical images and corresponding medical information to be transmitted and stored together. As shown in the example of FIG. 1, each of the enterprises 102b-d includes an XDS repository 110b-d that functions in a similar manner as the repository 110a of the hospital 102a.

Further, the repository 110a receives metadata associated with the images, medical reports, administrative information, and/or other clinical information from the medical information system 106 and forwards the metadata to the registry 104, which stores the metadata in a database 118. The metadata is used by the registry 104 to index the medical information stored at the repository 110a (along with the medical information stored at the repositories of the other enterprises 102b-d). The metadata corresponds to one of more types of identifying information (e.g., identification numbers, patient names, record numbers, social security numbers, or any other identifying) associated with, for example, medical reports stored at the repository 110a. As described in greater detail below, the registry 104 is capable of receiving queries into the contents of the repositories (e.g., the repository 110b of enterprise 102b) of the medical data sharing system 100 and using the indexed metadata to satisfy the queries. For example, the registry 104 can perform a search of its contents and provide feedback (e.g., requesting clinical data or an indication of the lack thereof) regarding the same to one or more of the enterprises 102a-d and/or, more specifically, the repositories 110a-d.

Further, the registry 104 includes an example patient clinical event tracking and alerting system 120. The tracking and alerting system 120 provides a feedback loop to healthcare practitioners for information related to clinical events experienced by former and/or current patients. Generally, the example tracking and alerting system 120 of FIG. 1 implements a subscribe-publish model to inform physicians concerned with a certain patient of medical events experienced by that patient. In particular, physicians (or any other type of healthcare practitioner) subscribe to one or more patients using the fore mentioned user interface of the workstation(s) 108. A record of each physician's subscriptions is stored and referenced by the tracking and alerting system 120 during a periodic polling session of the data shared among the enterprises 102a-d. If a new clinical event is detected at any of the enterprises 102a-d (e.g., in the repositories 110a-d as indicated by the indexed database 118 at the registry 104) during the polling session, the tracking and alerting system 120 determines which physician(s) (if any) are subscribed to the patient identified in the medical report associated with the detected new clinical event(s). Information associated with the detected clinical event is then published to the enterprise(s) 102a, 102b, 102c, and/or 102d associated with any subscribing practitioner(s) (e.g., to a hospital at which the practitioner works or an office from which the practitioner practices). In some examples, detected new clinical information to be sent to the enterprise(s) is screened or filtered to restrict the published data to only materials relevant to the subscribing practitioner's interaction with the patient associated with the new clinical data.

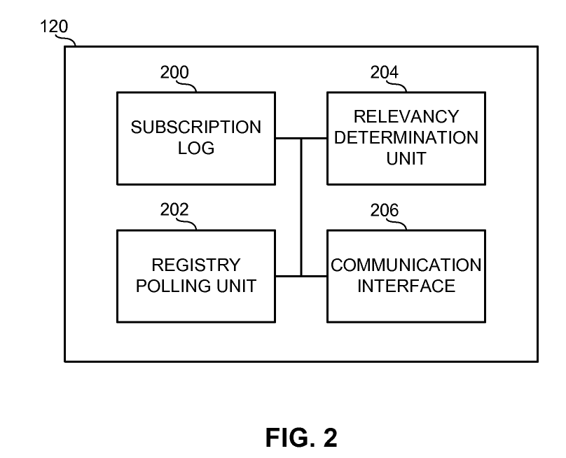

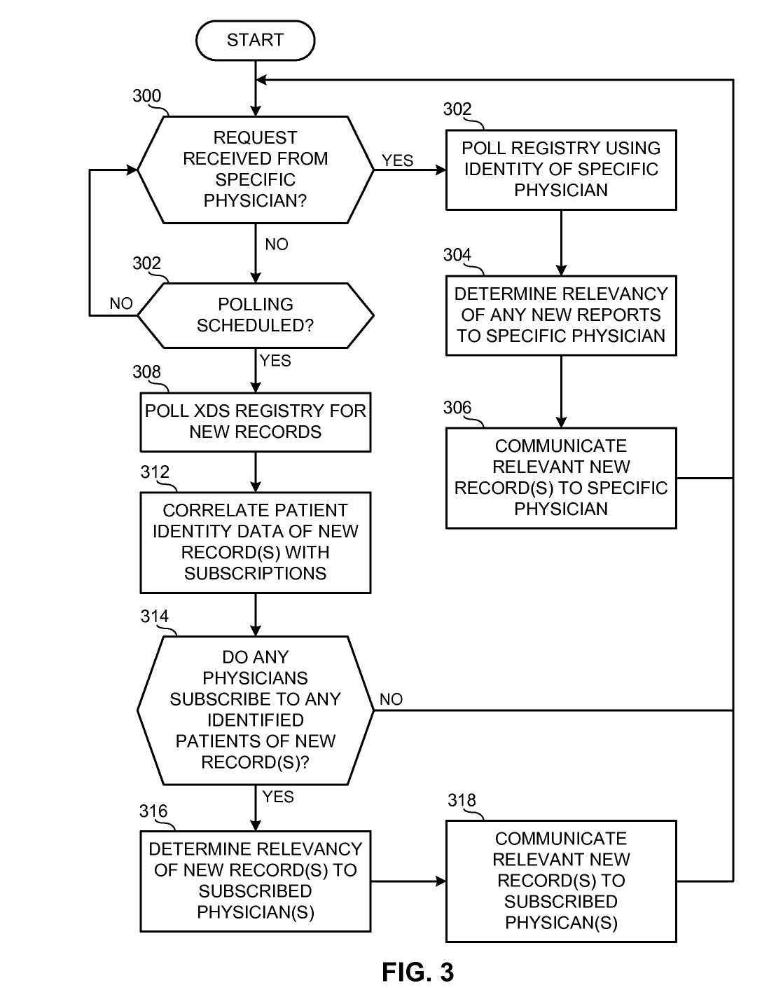

Advantageously, the example tracking and alerting system 120 enables healthcare professionals to remain informed of clinical events associated with current and/or former patients. As is the case with any type of learning environment, the more information one has regarding past approaches, conclusions, methods, techniques, etc., the more effectively one is able to evolve, improve, adapt, and/or, more generally, develop a medical practice and the skills involved therein. The feedback loop provided by the tracking and alerting system 120 provides information that can be used to, for example, confirm an initial diagnosis, identify a mistake, alter current practices, or make any other progress in healthcare treatment. Without the feedback loop provided by the example tracking and alerting system 120, physicians are more likely to be unaware of mistakes or ill-advised methods and, thus, more likely to repeat mistakes and/or continue to employ poor methods. Currently, such feedback is unavailable to many physicians or, in the cases in which the information is available, not easily accessible and requiring proactive searching that is difficult, inefficient, and often inaccurate. These factors, combined with demanding schedules of most practitioners, decrease the likelihood that a practitioner will take the time and effort to obtain the feedback. The example tracking and alerting system 120 is described in greater detail below in connection with FIGS. 2 and 3.

FIG. 2 is a block diagram of an example apparatus that may be used to implement the example tracking and alerting system 120 of FIG. 1. In the illustrated example of FIG. 2, the example tracking and alerting system 120 includes a subscription log 200, a registry polling unit 202, a relevancy determination unit 204, and a communication interface 206. While an example manner of implementing the tracking and alerting system 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example subscription log 200, the example registry polling unit 202, the example relevancy determination unit 204, the example communication interface 206, and/or, more generally, the example tracking and alerting system 120 of FIG. 2 may be implemented by hardware, software, firmware and/or any combination of hardware, software and/or firmware. Thus, for example, any of the example subscription log 200, the example registry polling unit 202, the example relevancy determination unit 204, the example communication interface 206, and/or, more generally, the example tracking and alerting system 120 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example subscription log 200, the example registry polling unit 202, the example relevancy determination unit 204, the example communication interface 206, and/or, more generally, the example tracking and alerting system 120 of FIG. 2 are hereby expressly defined to include a tangible medium such as a memory, DVD, CD, etc., storing the software and/or firmware. Further still, the example tracking and alerting system 120 of FIG. 2 may include one or more elements, processes and/or devices in addition to, or instead of, those illustrated in FIG. 2, and/or may include more than one of any or all of the illustrated elements, processes and devices.

To maintain a record of subscriptions received from one or more practitioners and/or the enterprises 102a-d, the example tracking and alerting system 120 of FIG. 2 includes the subscription log 200. As described above, a user interface implemented on the workstation(s) 108 enables one or more practitioners to subscribe to clinical events associated with one or patients. In some examples, the subscription process may be automated by, for example, generating a subscription for each patient a physician treats. When the tracking and alerting system 120 receives a subscription request, the subscription log 200 stores a unique identifier associated with the identified patient in association with a stored entry for the requesting physician. In the illustrated example, the physician entry is generated upon enrollment of the physician to the tracking and alerting system 120. The enrollment process includes the subscriber providing contact information (e.g., an email address, phone number, fax number, mailing address, etc.) and the tracking and alerting system 120 providing account information corresponding to the account created for the subscriber. After receiving and generating such information, the subscription log 200 stores the same in association with the entry for each subscribing physician.

To obtain clinical data (e.g., newly entered medical reports) designated to be shared among the enterprises 102a-d, the example tracking and alerting system 120 of FIG. 2 includes the registry polling unit 202. As described above, the registry 104 stores identifying data (e.g., metadata) in that database 118, which is indexed to efficiently organize the data stored therein. In the illustrated example, the polling unit 202 performs a periodic search of the database 118 to determine whether any previously unidentified clinical information is available. For example, when the polling unit 202 performs the search of the database 118 every twenty-four hours (e.g., in the morning hours or another time at which activity is minimal), the polling unit 202 may search for entries having a timestamp corresponding to the previous twenty-four hours and identify any such entries as new medical events. Additionally or alternatively, the polling unit 202 may maintain a list of previously identified entries, compare the list to the current contents of the database 118, and determine that any differences are newly entered medical events. Regardless of the method of searching, the polling unit 202 then generates a list of identified new medical events including, for example, patient identifiers, classifications, types of treatment, results, areas of practice, etc., any or all of which are designated by the metadata of the database 118.

To screen or filter the results provided by the polling unit 202, the example tracking and alerting system 120 of FIG. 2 includes the relevancy determination unit 204. As described above, not every medical event experienced by a patient may be published to a subscribing physician. Referring to the above example, a cardiologist who has treated a patient for an arrhythmia may subscribe to the future medical events experienced by the patient. If the patient injures a wrist in the months following the arrhythmia treatment, the polling unit 202 will detect the injury and generate a list or report including an indication thereof. However, before being published to the respective subscribers, the list or report is conveyed to the relevancy determination unit 204 to remove medical data not of particular interest to one or more of the subscribers. In the example described above, the relevancy determination unit 204 compares the characterization (e.g., as identified by metadata retrieved from the database 118 by the polling unit 202) of the wrist injury to the practice area of the cardiologist. Additionally or alternatively, the relevancy determination unit 204 may compare the characterization of the wrist injury to the type of treatment provided by the cardiologist. In this case, the relevancy determination unit 204 determines that the cardiologist will not receive the medical data associated with the wrist injury due to the stark differences in both the pertinent practice areas and types of treatment.

The relevancy determination unit 204 includes one or more algorithms to make the publication determination described above. For examples, the algorithms may access a plurality of tables including medical characterizations, practice areas, treatment types, and the associations there between. Such data may be assigned weights or values to indicate strength of association. The relevancy determination unit 204 may use additional or alternative methods to determine the clinical relationship between detected new medical events and the subscribing physician and/or the treated provided thereby.

To facilitate communication with the example components of the medical information system 100 described herein, the example tracking and alerting system 120 includes a communication interface 206. For example, the communication interface 206 may receive a list or report from the relevancy determination unit 204 including one or more entries from the database 118. In the illustrated example, the entries include metadata associated with one or more medical reports stored on the repositories 110a-d at the enterprises 102a-d. In the illustrated example, the metadata includes information regarding which repository the associated medical reports are stored. Thus, the communication interface 206 accesses the appropriate repository for each entry of the list or report to obtain the corresponding medical report(s).

Further, in the illustrated example, the list or report received by the communication interface 206 includes information regarding the identity of the subscribed physician(s) set to receive the newly identified medical report(s). Using such subscription information, the communication interface 206 then forwards the newly identified medical report(s) to the corresponding enterprise (e.g., the enterprise listed as the address of the subscribing physician). The newly identified medical report(s) can then be accessed at, for example, the workstation(s) 108 by, for example, logging into an account (e.g., using the user interface described above).

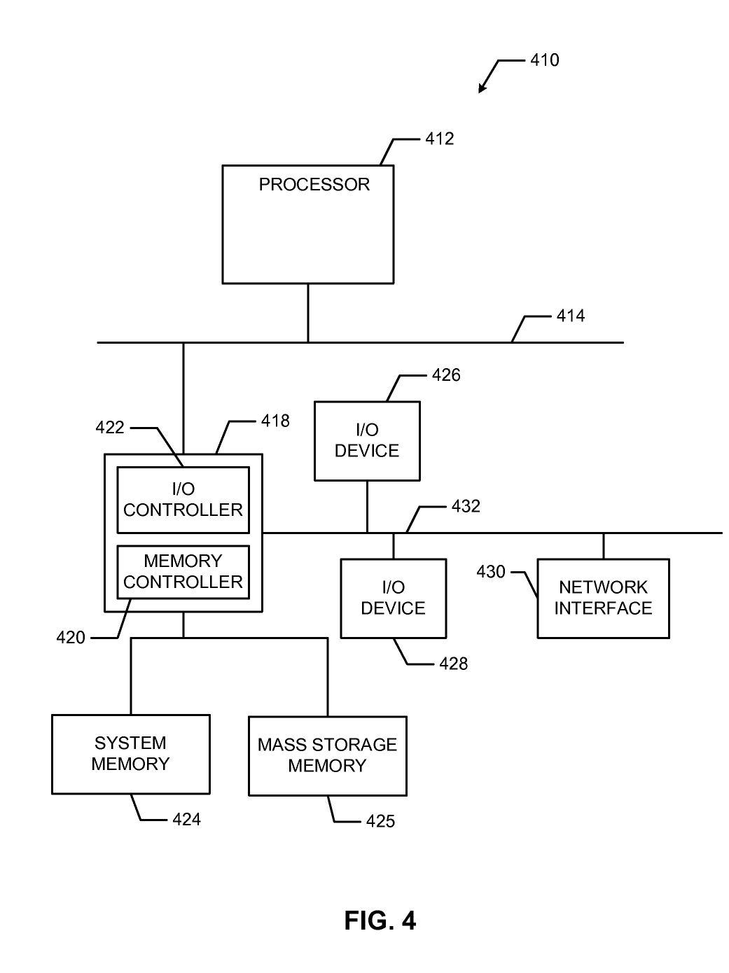

Turning to FIG. 3, the flow diagram depicted in FIG. 3 is representative of machine readable instructions that can be executed to implement the example methods and apparatus described herein. In particular, FIG. 3 depicts a flow diagram representative of machine readable instructions that may be executed to implement the example tracking and alerting system 120 of FIGS. 1 and/or 2 to provide a feedback loop to one or more healthcare practitioners. The example processes of FIG. 3 may be performed using a processor, a controller and/or any other suitable processing device. For example, the example processes of FIG. 3 may be implemented in coded instructions stored on a tangible medium such as a flash memory, a read-only memory (ROM) and/or random-access memory (RAM) associated with a processor (e.g., the example processor 412 discussed below in connection with FIG. 4). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagram of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

In the illustrated example of FIG. 3, polling of the registry 104 (FIG. 1) can be triggered by a request from a physician and/or a scheduled polling session. For example, if the tracking and alerting system 120 is configured to poll the registry 104 once per twenty-four hours, a physician may prefer to check for newly identified clinical information more frequently. Accordingly, a user interface (e.g., the user interface implemented by the workstation(s) 108 of FIG. 1) enables a subscribing physician to request a non-scheduled polling of the registry 104. If such a request is received by the tracking and alerting system 120 (block 300), the registry polling unit 202 (FIG. 2) polls the database 118 (FIG. 1) of the registry 104 using an identifier associated with the requesting physician (block 302). The unique identifier may be retrieved from or generated by, for example, the subscription log 200 (FIG. 2).

As described above, the registry polling unit 202 obtains any clinical records deemed to be new (e.g., recently entered into the medical data sharing system 100 of FIG. 1) and generates a list or record of the detected results. In the illustrated example, because the polling is performed in response to a specific request from a physician (block 300), the polling unit 202 may only include the results the search associated with the requesting physician (e.g., using the requesting physician's unique identifier in comparison with the metadata of the database 118). The list or record is then conveyed to the relevancy determination unit 204 (FIG. 2) to filter or screen the polling results (block 304). As described above, the relevancy unit 204 determines whether any newly obtained medical reports are pertinent to the clinical relationship between the requesting physician and the associated patient. Then, the communication interface 206 conveys any relevant clinical information to the requesting physician by, for example, retrieving the corresponding medical records from one or more of the repositories 110a-d (FIG. 1) and communicating the same to an account associated with the subscription (e.g., as obtained from the subscription log 200) of the requesting physician (block 306). The contents of the physician's account can then be accessed via one or more of the workstation(s) 108.

Referring back to block 300, when a specific request has not been received from a subscribing physician and a polling session is scheduled (block 308), the polling unit 202 obtains any clinical records deemed to be new (e.g., recently entered into the medical data sharing system 100 of FIG. 1) and generates a list or record of the detected results (block 310). When the polling unit 202 detects a newly entered medical report, the polling unit 202 also determines whether any subscriptions are present in the subscription log 200 corresponding to the patient associated with the newly entered medical report (block 312). If one or more of the detected medical reports involve patient(s) to which one or more physicians subscribe (block 314), the list or record generated by the polling unit 202 is conveyed to the relevancy determination unit 204. Otherwise, control returns to block 300.

As described above, the relevancy unit 204 determines whether any newly obtained medical reports are pertinent to the clinical relationship between the subscribing physician and the associated patient (block 316). Then, the communication interface 206 conveys any relevant clinical information to the requesting physician by, for example, retrieving the corresponding medical records from one or more of the repositories 110a-d (FIG. 1) and communicating the same to an account associated with the subscription (e.g., as obtained from the subscription log 200) of the requesting physician (block 318). The contents of the physician's account can then be accessed via one or more of the workstation(s) 108. Control then returns to block 300.

FIG. 4 is a block diagram of an example processor system 410 that may be used to implement the apparatus and methods described herein. As shown in FIG. 4, the processor system 410 includes a processor 412 that is coupled to an interconnection bus 414. The processor 412 may be any suitable processor, processing unit or microprocessor. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (I/O) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (SRAM), dynamic random access memory (DRAM), flash memory, read-only memory (ROM), etc. The mass storage memory 425 may include any desired type of mass storage device including hard disk drives, optical drives, tape storage devices, etc.

The I/O controller 422 performs functions that enable the processor 412 to communicate with peripheral input/output (I/O) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (ATM) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of providing feedback to healthcare practitioners, comprising:
receiving a subscription to clinical information associated with a patient from a healthcare practitioner;
searching a database of shared clinical information to identify recently entered clinical information, wherein searching the database is automated to be performed according to a schedule;
determining whether the recently entered clinical information includes medical data associated with the patient; and
publishing the medical data associated with the patient to the healthcare practitioner.

2. A method as defined in claim 1, wherein publishing the medical data associated with the patient to the healthcare practitioner comprises first determining a clinical relationship between the healthcare practitioner and the medical data and then publishing the medical data to the healthcare practitioner if the clinical relationship is includes a correlation.

3. A method as defined in claim 2, wherein determining the clinical relationship comprises comparing a type of treatment associated with the medical data to an area of practice of the healthcare practitioner.

4. A method as defined in claim 2, wherein determining the clinical relationship comprises comparing a type of treatment associated with the medical data to a type of treatment previously provided to the patient by the healthcare practitioner.

5. A method as defined in claim 2, wherein determining the clinical relationship comprises comparing a type of treatment associated with the medical data to an assignment of the healthcare practitioner for a multi-disciplinary team treating the patient.

6. A method as defined in claim 1, wherein the healthcare practitioner is a member of an enterprise agreeing to share clinical information with other enterprises over a medical data sharing system.

7. A method as defined in claim 1, wherein searching the database, determining whether the recently entered clinical information includes medical data associated with the patient, and publishing the medical data are automatically performed on a periodic basis.

8. A method as defined in claim 1, wherein searching the database, determining whether the recently entered clinical information includes medical data associated with the patient, and publishing the medical data are performed in response to a request by the healthcare practitioner.

9. An apparatus to provide feedback to a healthcare practitioner, comprising:
a subscription log to store a subscription to clinical information associated with a patient, wherein the subscription is received from a healthcare practitioner;
a polling unit to search a database of shared clinical information to identify recently entered clinical information and to determine whether the recently entered clinical information includes medical data associated with the patient, wherein the polling unit is to search the database automatically according to a schedule; and
a communication interface to publish the medical data associated with the patient to the healthcare practitioner.

10. An apparatus as defined in claim 9, further comprising a relevancy determination unit to determine a clinical relationship between the healthcare practitioner and the medical data.

11. An apparatus as defined in claim 10, wherein the clinical relationship is based on a comparison between a type of treatment associated with the medical data and an area of practice of the healthcare practitioner.

12. An apparatus as defined in claim 10, wherein the clinical relationship is based on a comparison between a type of treatment associated with the medical data and a type of treatment previously provided to the patient by the healthcare practitioner.

13. An apparatus as defined in claim 10, wherein the clinical relationship is based on a comparison between a type of treatment associated with the medical data and an assignment of the healthcare practitioner for a multi-disciplinary team treating the patient.

14. An apparatus as defined in claim 9, further comprising a user interface capable of receiving the subscription and conveying the medical data associated with the patient to the healthcare practitioner.

15. A medical data sharing system configured to provide feedback to a healthcare practitioner, comprising:
a plurality of medical information systems to receive clinical information implemented at a plurality of healthcare enterprises, wherein the enterprises are members of an agreement to share the clinical information;
a plurality of repositories implemented to store the clinical information;
a registry, in communication with the repositories, to store identifying data associated with the clinical information; and
a tracking and alerting system to automatically provide feedback to a plurality of healthcare practitioners by storing a plurality of subscriptions to clinical information associated with a plurality of patients, searching the registry to identify recently entered clinical information, wherein searching the registry is automated to be performed according to a schedule, and publishing the recently entered clinical information to a group of the healthcare practitioners according to the subscriptions.

16. A medical data sharing system as defined in claim 15, wherein the tracking and alerting system comprises a relevancy determination unit to determine a clinical relationship between a subscribing healthcare practitioner and a corresponding medical report associated with the recently entered clinical information.

17. A medical data sharing system as defined in claim 16, wherein the clinical relationship determines whether one or more of the group of healthcare practitioners receive the recently entered clinical data.

18. A medical data sharing system as defined in claim 15, further comprising one or more workstations to enable the healthcare practitioners to request the subscriptions and to receive the recently entered clinical information.

19. A medical data sharing system as defined in claim 15, wherein the identifying data comprises metadata generated by the medical information system.

20. A medical data sharing system as defined in claim 15, wherein the tracking and alerting system is implemented in at least one of the registry, the repositories, or the medical information system.
